(19) United States
(12) Patent Application Publication
(10) Pub. No.: US 2005/0021934 A1
(43) Pub. Date: Jan. 27, 2005

(54) Method for loading operating system

(76) Inventors: Chih-Chien Dong, Hsin-Tien City (TW); Chien-Fa Wang, Hsin-Tien City (TW)

Correspondence Address: J C PATENTS, INC., 4 VENTURE, SUITE 250, IRVINE, CA, 92618, US

(21) Appl. No.: 10/697,772

(22) Filed: Oct. 29, 2003

(30) Foreign Application Priority Data
Jul. 25, 2003 (TW) 92120366

(51) Int. Cl. G06F 15/177

(52) U.S. Cl. 713/1

(57) ABSTRACT

A method for loading an operating system is provided. A cluster-list-table is created and sorted by cluster information of operating system. Thereon the operating system is loaded according to the clusters-list-table. Thus the loading time for operating system is reduced and the loading speed thereof is increased accordingly.

### CROSS-REFERENCE TO RELATED APPLICATION

This application claims the priority benefit of Taiwan application serial no. 92120366, filed on Jul. 25, 2003.

### BACKGROUND OF THE INVENTION

1. Field of the Invention

The present invention relates to a method for loading a file, and more particularly, to a method for loading an operating system.

2. Description of the Related Art

Desktop computers, notebook computers, and industrial computers have been serving as common equipment for information processing for personal, office, or even manufacture purpose. However, various information electronic appliances, such as SetTopBox, WebPad, and Personal Digital Assistant (PDA) are introduced accordingly upon demand of miniaturization and user-friendliness.

A so-called Basic Input Output System (BIOS) or a bootloader commonly serves initialization of computer equipment or information electronic appliances to load an operating system for computer equipment or an Embedded Operating System (Embedded O. S.) for information appliances from a storage device therein.

Referring to FIG. 1, it is a flow chart illustrating a conventional method for loading a Windows CE embedded operating system. As shown in the drawing, when the apparatus applying such operating system is being booted, the bootloader searches for a NK.bin file in a file directory of a hard disk drive (S105) and indicates in step S110 whether the NK.bin file is found. If the NK.bin file is not found, which means the loading of operating system fails, the loading operation is terminated thereat. Conversely, if the NK.bin file is found, a first cluster number is obtained from a File Allocation Table (FAT) (S115) and is then converted to a cylinder number, a head number, and a sector number (S120), so as to read the file data from the hard disk drive correspondingly (S125). Afterwards, a next cluster is searched (S130) and is judged by its availability, either returning to step S120 with positive judgement, or indicating operating system loading complete with negative judgement.

In such conventional method for loading an operating system, since the clusters where the operating system file is saved can randomly distribute in different cylinders, heads, and sectors, it can be a waste of time moving the read/write head between different cylinders, heads, and sectors for reading the file data.

### SUMMARY OF THE INVENTION

Accordingly, the present invention provides a method for loading an operating system. The method generates a cluster-list-table that saves the sorted operating system file therein, such that the loading of operating system is performed according to the cluster-list-table, and thus loading time of operating system is reduced.

In order to achieve the object above and others, the present invention provides a method for loading an operating system from a storage device such as a hard disk drive or a flash drive, so as to save loading time of the operating system. The method for loading the operating system comprises the steps of determining whether the operating system being first time booted, a cluster-list-table being made if being first boot; and the operating system being loaded based on the cluster-list-table that is made.

In one preferred embodiment of the present invention, in order to determine if the loaded operating system file has been replaced so as to determine whether to re-build a cluster-list-table or not, the method for loading the operating system further comprises the following steps. Judging whether being the operating system being first time booted; generating a check sum for the operating system if being first boot; and determining whether the operating system file has been modified based on the check sum that is made.

In one preferred embodiment of the operating system loading method in the present invention, creating the cluster-list-table comprises the following steps. Searching for a plurality of clusters where the operating system file being saved, and sorting the clusters and saving as a cluster-list-table according to the cluster information. If the storage device being a hard disk drive, the cluster-list-table sorting is performed based on the cylinder number, the head number, and the sector number.

According to the foregoing description, the present invention provides a loading method for an operating system. The clusters where the operating system file is saved are sorted and saved as a cluster-list-table, and the operating system file is loaded accordingly, thus loading time is saved, that is, operating system loading is accelerated.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a flow chart illustrating a conventional method for loading a Windows CE embedded operating system.

FIG. 2 is a flow-chart illustrating a method for loading an operating system according to one preferred embodiment in the present invention.

FIG. 3 schematically shows a cluster-list-table of the operating system file before and after sorting according to one preferred embodiment in the present invention.

FIG. 4 schematically shows a cluster distribution in a hard disk drive according to one preferred embodiment of the present invention.

FIG. 5 schematically shows distance which the read/write head needs to move before the cluster-list-table is sorted according to one preferred embodiment of the present invention.

FIG. 6 schematically shows distance which the read/write head needs to move after the cluster-list-table is sorted according to one preferred embodiment of the present invention.

FIG. 7 is a flow-chart illustrating a method for loading an operating system according to one preferred embodiment in the present invention.

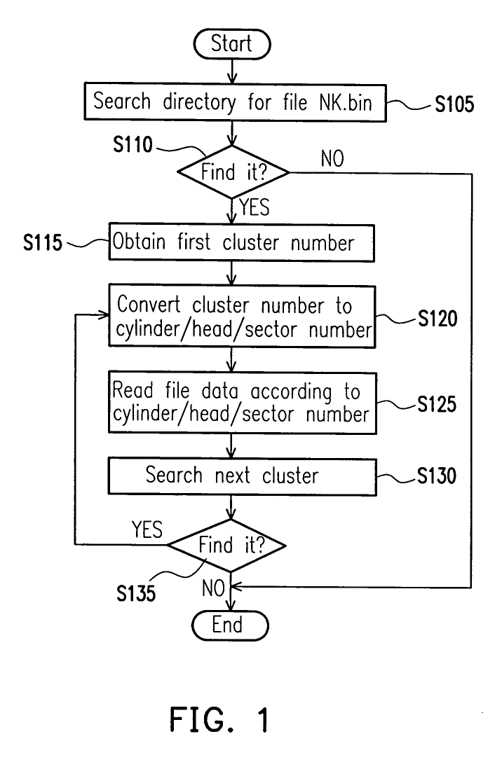

### DESCRIPTION OF THE PREFERRED EMBODIMENTS

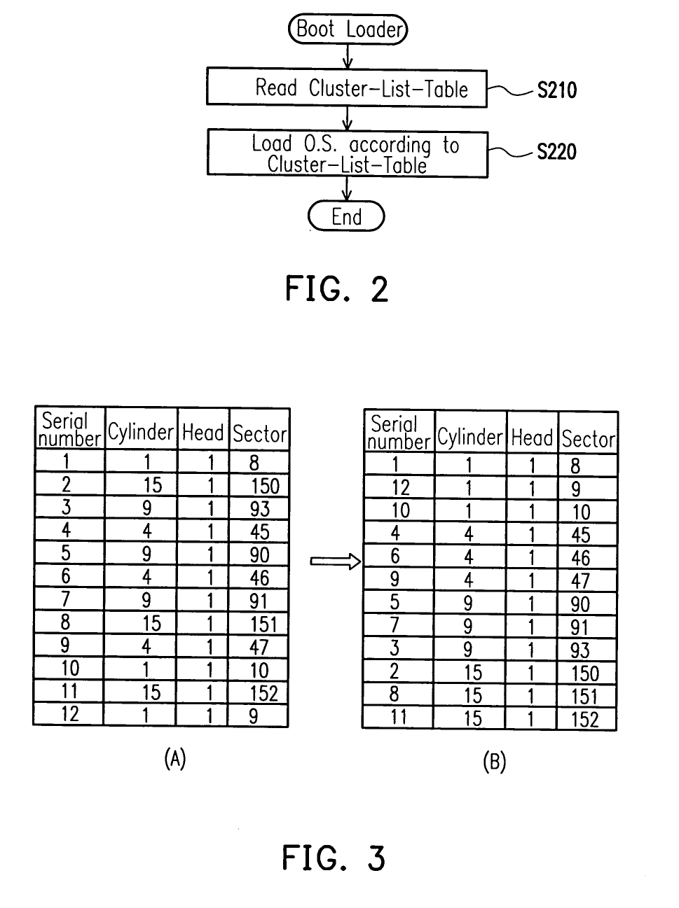

FIG. 2 is a flow-chart illustrating a method for loading an operating system of a preferred embodiment according to the present invention. In order to avoid time waste in moving the read/write head between different cylinders/heads/sectors where the operating system file is distributed, the clusters are sorted and saved into a cluster-table-list in advance so as to be read accordingly (as shown in S210 in FIG. 2). Hence the operating system file is read based on the cluster-list-table (as shown in S220), and loading time of operating system is reduced thereby.

Referring to FIG. 3, it schematically shows an exemplary cluster-list-table of the operating system file before and after sorting. Table (A) is a cluster-list-table of the operating system file before sorted, wherein the serial number represents the order of reading the operating system file. As shown therein, if the operating system file is read based on the present sequence, the read/write head continuously moves between different cylinders being read, which causes time waste thereby. Therefore, the cluster-list-table can be defined by following array structure:

```
struct Cluster-list-table {
  ULONG ulNumber;
  ULONG ulSector;
  ULONG ulCylinder;
  ULONG ulHead;
} ClustersList[ ];
```

afterwards, the table (A) is sorted according to a new sequence of the cylinder, head, and sector numbers as shown in table (B), and the operating system is loaded according to the sequence shown in table (B), so as to save loading time of the operating system. Thus operating system loading speed is accelerated accordingly.

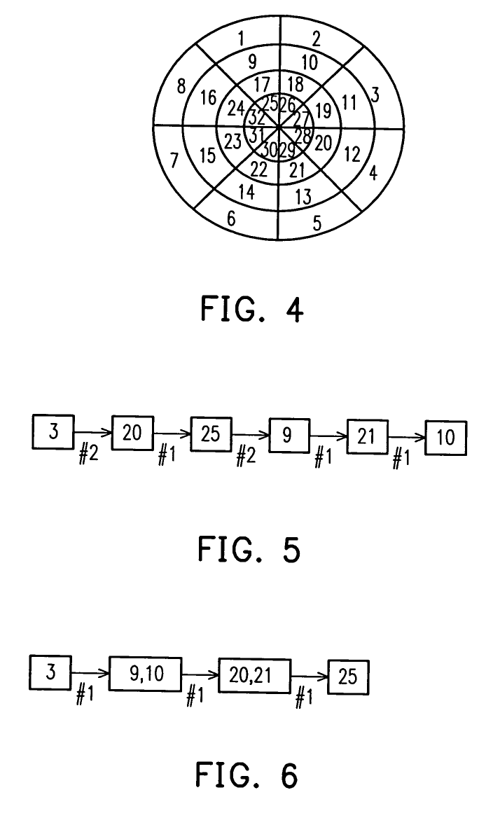

Referring to FIG. 4, it schematically shows a cluster distribution in a hard disk drive. In the hard disk drive of the present case, assuming each cluster only has one sector, and the sequence for saving the operating system file is 3, 20, 25, 9, 21, and 10. When the operating system file is read according to the foregoing sequence, the distance that the read/write head travels is as shown in FIG. 5. That is, moving by two tracks from cluster 3 to cluster 20, by one track from cluster 20 to cluster 25, by 2 tracks from cluster 25 to cluster 9, by one track from cluster 9 to cluster 21, and by one track from cluster 21 to cluster 10. Thus the total tracks en route is 2+1+2+1+1=7. Whereas when the cluster-list-table is sorted as mentioned above and the operating system file is read according to the cluster-list-table after sorted, the distances that the read/write head travels is as shown in FIG. 6. That is, the total number of tracks en route is 1+1+1=3, thus the operating system is promptly loaded.

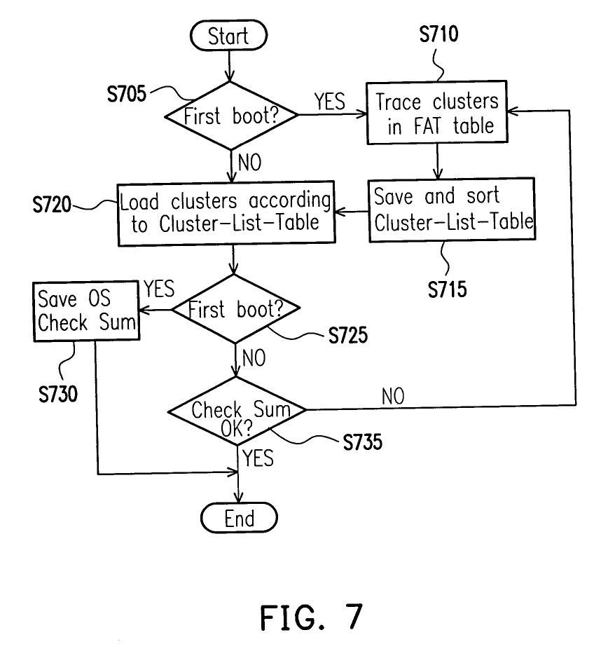

FIG. 7 is a flow-chart illustrating a method for loading an operating system of a preferred embodiment according to the present invention, and is described as follows. Judging if the operating system being first boot in S705, jumping to S710 for searching a plurality of clusters where operating system file is saved if positive judgement, being followed by S715 for sorting cluster information that is found and saving as a cluster-list-table. Then jumping to S720 for loading operating system according to the cluster-list-table thereof.

Taking the case into account herein that the operating system file to be loaded may be changed. As operating system file is read, judging if being first boot in S725. Proceeding to S730 to generate CheckSum for the operating system according to the operating file if being first boot, whereas proceeding to S735 if not being first boot so that to judge if operating system is changed according to the CheckSum. If erroneous CheckSum is provided which means a change of operating system is diagnosed, return to S710 so as to rebuild the cluster-list-table. Otherwise operating system loading is completed.

Although the present invention has described the case where the operating system is stored in a hard disk drive, it will be apparent to one of the ordinary skilled in the art that the method is also applicable to a flash drive. Wherein burst mode serves to read the clusters on the same bank, so as to accelerate the operating system loading.

Although the invention has been described with reference to a particular embodiment thereof, it will be apparent to one of the ordinary skilled in the art that modifications to the described embodiment may be made without departing from the spirit of the invention. Accordingly, the scope of the invention will be defined by the attached claims not by the above detailed description.

1. An operating system loading method, for loading an operating system from a storage device, comprising:
judging whether the operating system is first time booted or not;
creating a cluster-list-table if booting the operating system is judged first time; and
loading the operating system according to the cluster-list-table.

2. The operating system loading method of claim 1, further comprising:
judging whether the operating system is first time booted or not;
generating a check sum if booting the operating system is judged first time; and
judging whether an operating system file is modified or not based on the check sum.

3. The operating system loading method of claim 1, wherein making the cluster-list-table comprises:
searching a plurality of clusters where the operating system file is saved; and
sorting and saving as the cluster-list-table thereof according to information on the clusters.

4. The operating system loading method of claim 1, wherein the storage device is a hard disk drive.

5. The operating system loading method of claim 4, wherein the cluster-list-table is sorted based on a cylinder number, a head number, and a sector number.

6. The operating system loading method of claim 1, wherein the storage device is a flash drive.

7. The operating system loading method of claim 1, wherein the operating system is an embedded operating system.

8. An operating system loading method, for loading an operating system from a storage device, comprising:
reading a cluster-list-table; and
loading the operating system according to the cluster-list-table.

9. The operating system loading method of claim 8, further comprising:
judging whether the operating system is first time booted or not;
generating a check sum for the operating system if loading the operating system is judged first time; and
judging whether an operating system file is modified or not based on the check sum.

10. The operating system loading method of claim 8, further comprising:
judging whether the operating system is first time booted or not;
searching a plurality of clusters where the operating system file is saved if loading the operating system is judged first time; and
sorting and saving as the cluster-list-table thereof according to information on the clusters.

11. The operating system loading method of claim 8, wherein the storage device is a hard disk drive.

12. The operating system loading method of claim 11, wherein the cluster-list-table is sorted based on a cylinder number, a head number, and a sector number.

13. The operating system loading method of claim 8, wherein the storage device is a flash drive.

14. The operating system loading method of claim 8, wherein the operating system is an embedded operating system.
